(19) United States
(12) Patent Application Publication
(10) Pub. No.: US 2010/0176066 A1
(43) Pub. Date: Jul. 15, 2010

(54) Method of Improving Efficiency of UV Photolysis of Peracetic Acid for Disinfection and Organic Destruction

(75) Inventors: Frederic E. Budde, Eagan, MN (US); Mark K. Vineyard, Houston, TX (US)

Correspondence Address: BANNER & WITCOFF, LTD., 1100 13th STREET, N.W., SUITE 1200, WASHINGTON, DC, 20005-4051, US

(73) Assignee: PERAGEN SYSTEMS INC., Eagan, MN (US)

(21) Appl. No.: 12/634,003

(22) Filed: Dec. 9, 2009

Related U.S. Application Data
(60) Provisional application No. 61/120,866, filed on Dec. 9, 2008.

(51) Int. Cl. C02F 9/12

(52) U.S. Cl. 210/748.1

(57) ABSTRACT

A method of disinfecting municipal wastewaters comprises contacting the wastewater with a peracetic acid solution containing a relatively low amount of hydrogen peroxide in the presence of ultraviolet irradiation. In another aspect, a source of UV irradiation is selected to emit energy at one or more wavelengths at which PAA absorption is optimized or economized. The enhanced UV-PAA process may be used in a variety of other disinfection and organic destruction processes.

### CROSS REFERENCE TO RELATED APPLICATION

This application claims priority under 35 U.S.C. §119(e) to U.S. Provisional Application No. 61/120,866, filed Dec. 9, 2008, the disclosure of which is hereby incorporated by reference in its entirety.

### BACKGROUND

Several studies have reported enhanced disinfection of municipal wastewaters by combining ultraviolet (UV) irradiation with low dosages of peracetic acid (PAA), sometimes referred to as “UV-PAA.” Such enhanced performance has been attributed to the presence of PAA at the point of UV irradiation. It has been postulated that acetate radicals are generated in situ from the absorption of UV irradiation by PAA. Rajala-Mustonen et al., “Effects of Peracetic Acid and UV Irradiation on the Inactivation of Coliphages in Wastewater,” Water Science and Technology, 35(11-12):237-241 (1997); Caretti et al., “Wastewater Disinfection with PAA and UV Combined Treatment: a Pilot Plant Study,” Water Research, 37:2365-2371 (2003); Lubello et al., “Municipal-treated Wastewater Reuse for Plant Nurseries Irrigation,” Water Research, 38(12):2939-2947 (July 2004); Koivenen et al., “Inactivation of Enteric Microorganisms with Chemical Disinfectants, UV Irradiation and Combined Chemical/UV treatments,” Water Research 39(8):1519-1526 (April 2005); Madrid et al., “Photo-activated Peracetic Acid Enhances UV Disinfection of Wastewater Effluents,” Water Environment Federation, pp 7706-7715 (2005); Martin et al., “Reduction of Photoreactivation with the Combined UV/Peracetic Acid Process or by Delayed Exposure to Visible Light,” Water Environment Research, 79(9):991-999 (September 2007). Some of these authors note the process shows promise for reducing the size (e.g., power consumption) of UV irradiation apparatus needed for a particular application, while others note that important shortcomings of UV irradiation (e.g., microbial occlusion with particles and photo-repair/re-growth of irradiated microbes, blackbody irradiation/algal growth within the UV device) can be overcome with the combination.

The production of acetate radicals suggests a second capability of UV-PAA, namely that the produced acetate radicals may degrade organic substances, similar to other Advanced Oxidation (AOx) Processes. Anipsitakis et al., “Activation of Common Oxidants by Transition Metals for Water Decontamination,” Div. of Environ. Chem., Am. Chem. Soc. (Sep. 7-11, 2003); Mokrini et al., “Oxidation of Aromatic Compounds with UV Radiation/Ozone/Hydrogen Peroxide,” Water Science and Technology, 35(4): 95-102 (1997).

For disinfection applications, this implies that the UV-PAA combination can remove organic contaminants (e.g., endocrine disruptors such as estrogenic compounds from municipal wastewater) while boosting the degree of disinfection. These combined functions are particularly valued, for example, when municipal wastewater effluents are to be re-used for irrigation, recreation, or groundwater storage, or to protect the natural aquatic diversity of receiving waters, such as lakes, streams, or estuaries.

### BRIEF SUMMARY

In one aspect, a method of disinfecting municipal wastewaters comprises contacting the wastewater with a peracetic acid (PAA) solution containing a relatively low amount of hydrogen peroxide (H₂O₂) in the presence of ultraviolet (UV) irradiation. The PAA solution usually contains a weight ratio of peracetic acid to hydrogen peroxide, PAA: H₂O₂, of ≧3:1. In some instances, this ratio may be significantly higher. For example, the PAA solution may be free or substantially free of H₂O₂. The PAA solution also may be free or substantially free of acetic acid and/or mineral acid, for example, sulfuric acid.

In another aspect, a UV-PAA process involves using a source of UV irradiation which emits energy at one or more wavelengths at which PAA absorption is optimized or economized.

The UV-PAA processes described herein are useful in a variety of applications, non-limiting examples of which include disinfection of vapor/air and/or water/wastewater for residential, municipal, commercial, and industrial purposes (drinking water, etc.); surface sanitizing, e.g., in horticultural operations, animal rearing facilities, food establishments, and medical facilities; destruction of microbial spores, e.g., biodecontamination areas and food storage/processing/aseptic packaging operations; production of chemical products/intermediates that utilize the acetate radical in their manufacture/purification; including the initiation of polymerization reactions within the chemical manufacturing and materials processing industries; destruction of volatile organic compounds (including odors) present in waste gases and air ventilation systems; destruction of environmental contaminants such as petroleum hydrocarbons, pesticides/pharmaceuticals, and industrial solvents present in water and wastewater or on material surfaces amenable to fumigation and UV exposure; bleaching of synthetic and/or natural products such as chemical solvents/surfactants, clays/talcs/minerals, mineral acids, fats/oils, pulp/paper, textiles/fabrics, and waste effluents; delignification/predigestion of biomass materials such as wood pulps and agricultural residues/extracts; and modification/etching of material surfaces such as metals and their alloys, synthetic polymers comprised of organic and/or inorganic substances, or naturally-occurring products, including nanomaterials and semiconductors.

### DETAILED DESCRIPTION OF THE INVENTION

The efficiency of ultraviolet (UV) photolysis of peracetic acid (PAA) in a variety of types of disinfection and organic destruction processes (hereinafter sometimes “UV-PAA”) may be enhanced according to one or more aspects described herein. In one aspect, a peracetic acid (PAA) formulation is selected to contain a low relative amount of hydrogen peroxide (H₂O₂). In another aspect, UV irradiation is applied at one or more wavelengths at which PAA absorption is optimized or economized.

Unless otherwise clear from context, all percentages described herein refer to amounts in percent by weight.

The source of UV irradiation may be low-pressure mercury vapor lamps or medium-pressure high-output lamps. Such lamps may emit either narrow or broad spectrum wavelengths, either continuously or intermittently (i.e., pulsed). The UV irradiation may also be a laser that emits monochromatic or near monochromatic irradiation at wavelengths absorbed by peracetic acid (i.e., preferential to acetate radical generation). For disinfecting municipal wastewater effluents, for example, the UV lamp source may be a low-pressure or medium-pressure mercury vapor lamp that incorporates one or more dopants known to increase the emission of wavelengths preferential to acetate radical generation.

It is known that many substances absorb UV irradiation at wavelengths in the germicidal range (253.7 nm). For example, UV transmittance (UV-T) of 65-85% are typical for secondary treated municipal effluents, where UV-T correlates to Dissolved Organic content. These substances compete for available UV energy and their presence increases the amount needed for an application, and hence increases both the capital and operating costs. In the case of H₂O₂ (a major component in most equilibrium PAA formulations), its UV absorption can impair UV performance. This has been documented by atmospheric research that characterized the UV absorption cross sections for gaseous PAA, H₂O₂, and acetic acid (Table 1). Orlando et al., “Gas Phase UV Absorption Spectra for Peracetic Acid, and for Acetic Acid Monomers and Dimers,” J. Photochemistry and Photobiology A: Photochemistry (April 2002).

TABLE 1
UV absorption cross sections for peracetic
acid, hydrogen peroxide and acetic acid

| | (10⁻²¹ cm² molecule⁻¹) | |
|---|---|---|
| Wavelength | | HOAc |

| nm | PAA | H2O2 | Monomer | Dimer |
|---|---|---|---|---|
| 185 | | | | |
| 190 | | | | |
| 195 | | 573 | | |
| 200 | | 507 | | |
| 205 | | 426 | | |
| 210 | 381 | 372 | 151 | 234 |
| 215 | 275 | 317 | 130 | 171 |
| 220 | 189 | 274 | 105 | 109 |
| 225 | 130 | 223 | 77 | 58 |
| 230 | 91 | 188 | 51 | 24.5 |
| 235 | 67 | 155 | 31.7 | 8.8 |
| 240 | 50.3 | 130 | 16.4 | 2.7 |
| 245 | 40.6 | 105 | 8.5 | |
| 250 | 30.5 | 87 | | |
| 255 | 22.9 | 71 | | |
| 260 | 17.1 | 54 | | |
| 265 | 12.80 | 43.7 | | |
| 270 | 9.45 | 34.5 | | |
| 275 | 7.00 | 26.7 | | |
| 280 | 5.06 | 19.9 | | |
| 285 | 3.60 | 15.5 | | |
| 290 | 2.56 | 12.18 | | |
| 295 | 1.81 | 9.03 | | |
| 300 | 1.23 | 6.33 | | |
| 305 | 0.87 | 5.25 | | |
| 310 | 0.62 | 4.20 | | |
| 315 | 0.42 | 3.05 | | |
| 320 | 0.25 | 2.06 | | |
| 325 | 0.185 | 1.85 | | |
| 330 | 0.125 | 1.53 | | |
| 335 | 0.100 | 1.15 | | |
| 340 | 0.060 | 0.70 | | |
| 345 | | 0.57 | | |
| 350 | | 0.50 | | |
| 360 | | 0.0380 | | |
| 380 | | 0.0085 | | |
| 400 | | 0.0025 | | |

Table 1 shows that, on a molar basis, H₂O₂ absorbs over three times the energy as PAA at the germicidal wavelength of 253.7 nm (“UV-254”). On a weight-adjusted basis, this preference equates to a 7:1 selectivity of UV-254 toward H₂O₂ over PAA. To better illustrate the effect, equilibrium formulations of PAA (which contain high relative amounts of H₂O₂ and/or acetic acid) were compared to distilled solutions of PAA (which contain almost no H₂O₂ and very little acetic acid). The comparative compositions are shown in Table 2 below. Since PAA exists in equilibrium with H₂O₂ and acetic acid (and water), it is possible to achieve the PAA content by substituting an excess of one reactant for the other. Thus, there are PAA formulations that have very low H₂O₂ content but very high acetic acid content, and vice-versa, as well as combinations in between. However, the low H₂O₂ formulations of equilibrium PAA are not practical for many applications due to the high organic contribution from the acetic acid. For example, when disinfecting municipal wastewater effluents, the permitted Biochemical Oxygen Demand (BODS) discharge limits may be exceeded. All equilibrium peracetic acid formulations (lower acetic acid or lower H₂O₂) tend to be impractical for many applications due to their cost, directly related to the poor yields achieved on the key raw materials, acetic acid and H₂O₂.

Table 2 also includes solutions of PAA produced by the vacuum distillation of (near) equilibrium solutions of PAA. These distillate solutions contain virtually no H₂O₂ or sulfuric acid and only small amounts of acetic acid, and consists essentially of PAA and water (aqueous PAA).

TABLE 2

| | PAA | H₂O₂ | Acetic Acid | Water | Sulfuric Acid |
|---|---|---|---|---|---|
| | (%) | (%) | (%) | (%) | (%) |
| Equilibrium | 5 | 22 | 10 | 63 | 1 |
| Formulations | 10 (1) | 1 | 78 | 11 | 1 |
| | 10 (2) | 18 | 18 | 52 | 1 |
| | 15 (1) | 14 | 25 | 42 | 1 |
| | 15 (2) | 23 | 16 | 45 | 1 |
| Distilled | 25 | <1 | 2-3 | 73 | <0.01 |
| Formulations | 35 | <1 | 2-3 | 62 | <0.01 |

Table 3 shows the effect of aqueous PAA on the UV-T of deionized water. No effect was observed at doses up to 100 mg/L PAA. This indicates that PAA, in and of itself, does not exert a significant demand on the applied germicidal UV energy.

TABLE 3

| | PAA Dose | | Loss |
|---|---|---|---|
| Sample No. | (mg/L) | 254 nm UV | UV-T (%) |
| 1 (control) | 0 | 100 | 0 |
| 2 | 5 | 100 | 0 |
| 3 | 10 | 100 | 0 |
| 4 | 20 | 100 | 0 |
| 5 | 30 | 100 | 0 |
| 6 | 100 | 100 | 0 |

Table 4, on the other hand, shows a notable loss in UV-T when an intermediate equilibrium grade of PAA is used (e.g., one having approximately equal amounts of H₂O₂ and acetic acid). This result indicates a significant loss of germicidal UV energy.

TABLE 4

| | PAA Dose | H₂O₂ Dose | 254 nm UV | Loss |
|---|---|---|---|---|
| Sample No. | (mg/L)* | (mg/L) | Transmission (%) | UV-T (%) |
| 7 (control) | 0 | 0 | 100 | 0 |
| 8 | 5 | 5.8 | 99 | 1 |
| 9 | 10 | 11.5 | 97 | 3 |
| 10 | 20 | 23 | 95 | 5 |
| 11 | 30 | 35 | 94 | 6 |
| 12 | 100 | 115 | 82 | 18 |

*Equilibrium PAA = 9.74% PAA, 11.20% H₂O₂, 19.76% acetic acid, 58.30% water, and 1% sulfuric acid.

To confirm the H₂O₂ component in equilibrium PAA formulations as responsible for the UV-254 absorption, a series of tests were performed where acetic acid and H₂O₂ were spiked into deionized water and then dosed with aqueous PAA. Table 5 shows no measurable effect with the addition of acetic acid; whereas Table 6 suggests that essentially all the effect seen with equilibrium PAA is due to the presence of H₂O₂.

TABLE 5

| | PAA Dose | Acetic Acid | 254 nm UV | Loss |
|---|---|---|---|---|
| Sample No. | (mg/L) | Dose (mg/L) | Transmission (%) | UV-T (%) |
| 13 (control) | 0 | 0 | 100 | 0 |
| 14 | 10 | 0 | 100 | 0 |
| 15 | 10 | 5 | 100 | 0 |
| 16 | 10 | 10 | 100 | 0 |
| 17 | 10 | 20 | 100 | 0 |
| 18 | 10 | 30 | 100 | 0 |
| 19 | 10 | 100 | 100 | 0 |
| 20 | 10 | 200 | 100 | 0 |

TABLE 6

| | PAA Dose | H₂O₂ Dose | 254 nm UV | Loss |
|---|---|---|---|---|
| Sample No. | (mg/L) | (mg/L) | Transmission (%) | UV-T (%) |
| 21 (control) | 0 | 0 | 100 | 0 |
| 22 | 10 | 0 | 99 | 1 |
| 23 | 10 | 5 | 98 | 2 |
| 24 | 10 | 10 | 97 | 3 |
| 25 | 10 | 20 | 95 | 5 |
| 26 | 10 | 30 | 94 | 6 |
| 27 | 10 | 100 | 86 | 14 |

In one aspect, a PAA solution adapted for UV-PAA processes has a ratio of PAA: H₂O₂ of ≧3:1. This ratio may be higher, for example, ≧4:1,≧5:1,≧6:1,≧7:1,≧8:1,≧9:1, or ≧10:1. Significantly higher ratios may be present, for example in the case where the PAA solution is free or substantially free of H₂O₂ and/or sulfuric acid. The PAA solution also may be free or substantially free of acetic acid and/or sulfuric acid. PAA solutions substantially free of H₂O₂ and acetic acid may be produced, e.g., by the vacuum distillation of (near) equilibrium solutions of PAA.

A second aspect anticipates that the efficiency of acetate radical generation (based on PAA dose and UV energy input) will be significantly improved by employing one or more emission wavelengths where absorption by PAA is maximized. Such wavelengths can be readily identified by a straightforward scan of the UV spectrum. In this manner, the amount of UV energy and/or PAA needed to achieve a given level of microbial kill (or organic destruction) may be further economized. In the case where the objective is not disinfection (e.g., environmental contaminant destruction) the UV source may be chosen to maximize energy efficiency in producing UV at wavelength(s) optimal for acetate radical generation from PAA.

Suitable UV wavelengths optimal for PAA absorption and/or acetate radical generation may be determined during the course of routine experimentation and may fall within the range of about 160 nm to about 400 nm. The optimal wavelength(s) may range from about 160 nm to about 170 nm, from about 170 nm to about 180 nm, from about 180 nm to about 190 nm, from about 190 nm to about 200 nm, from about 200 nm to about 210 nm, from about 210 nm to about 220 nm, from about 220 nm to about 230 nm, from about 230 nm to about 240 nm, from about 240 nm to about 250 nm, from about 250 nm to about 260 nm, from about 260 nm to about 270 nm, from about 270 nm to about 280 nm, from about 280 nm to about 290 nm, from about 290 nm to about 300 nm, from about 300 nm to about 310 nm, from about 310 nm to about 320 nm, from about 320 nm to about 330 nm, from about 330 nm to about 340 nm, from about 340 nm to about 350 nm, from about 350 nm to about 360 nm, from about 360 nm to about 370 nm, from about 370 nm to about 380 nm, from about 380 nm to about 390 nm, or from about 390 nm to about 400 nm. The selected UV wavelengths may also be one or more wavelengths where the benefits derived from efficient acetate radical generation (from PAA) are reconciled with the inherent production of undesirable products such as nitrate (from nitrogen gas). Such wavelengths may fall within any of the aforementioned ranges.

In the case of municipal wastewater disinfection, PAA can be applied to the wastewater treatment final stage, e.g., at a concentration ranging from about 0.5 to 15 mg/L, to achieve disinfection and/or micro-contaminant destruction standards for discharge to a receiving watershed. In older construction specifications, PAA may be applied directly into an existing disinfection basin, such a basin exhibiting plug flow characteristics previously used for conventional chlorine based disinfection processes. UV irradiation may be simultaneously applied using a suitable source of ultraviolet radiation as previously described or applied at any point within or after the disinfection basin yet after PAA injection into the wastewater.

Other non-limiting applications for the UV-PAA processes described herein include disinfection of vapor/air and/or water/wastewater for residential, municipal, commercial, and industrial purposes (drinking water, etc.); surface sanitizing as may be needed in e.g., horticultural operations, animal rearing facilities, food establishments, and medical facilities; destruction of microbial spores as may be needed for e.g., biodecontamination areas and food storage/processing/aseptic packaging operations; production of chemical products/intermediates that utilize the acetate radical in their manufacture/purification; including the initiation of polymerization reactions within the chemical manufacturing and materials processing industries; destruction of volatile organic compounds (including odors) present in waste gases and air ventilation systems; destruction of environmental contaminants such as petroleum hydrocarbons, pesticides/pharmaceuticals, and industrial solvents present in water and wastewater or on material surfaces amenable to fumigation and UV exposure; bleaching of synthetic and/or natural products such as chemical solvents/surfactants, clays/talcs/minerals, mineral acids, fats/oils, pulp/paper, textiles/fabrics, and waste effluents; delignification/predigestion of biomass materials such as wood pulps and agricultural residues/extracts; and modification/etching of material surfaces such as metals and their alloys, synthetic polymers comprised of organic and/or inorganic substances, or naturally-occurring products, including nanomaterials and semiconductors. Suitable PAA concentrations for such applications will be evident to persons skilled in the art with the aid of no more than routine experimentation. PAA concentrations generally range from about 1 to about 1,000 mg/L for liquid phase applications and from about 1 to about 1,000 ppmV for vapor phase applications.

While the invention has been described with respect to specific examples including presently preferred modes of carrying out the invention, those skilled in the art will appreciate that there are numerous variations and permutations of the above described systems and techniques. Thus, the spirit and scope of the invention should be construed as broadly disclosed herein.

What is claimed is:

1. A method of disinfecting municipal wastewater comprising contacting the wastewater with a peracetic acid solution in the presence of ultraviolet irradiation, wherein the peracetic acid solution contains a weight ratio of peracetic acid to hydrogen peroxide of ≧3:1.

2. The method of claim 1 wherein the weight ratio of peracetic acid to hydrogen peroxide is ≧4:1.

3. The method of claim 2 wherein the weight ratio of peracetic acid to hydrogen peroxide is ≧6:1.

4. The method of claim 3 wherein the weight ratio of peracetic acid to hydrogen peroxide is ≧8:1.

5. The method of claim 4 wherein the weight ratio of peracetic acid to hydrogen peroxide is ≧10:1.

6. The method of claim 5 wherein the PAA solution is free or substantially free of hydrogen peroxide.

7. The method of claim 1 wherein the PAA solution is free or substantially free of acetic acid.

8. The method of claim 1 wherein the PAA solution is free or substantially free of mineral acid.

9. A method of treating a medium with a peracetic acid solution in the presence of ultraviolet irradiation, the method comprising contacting the medium with a peracetic acid solution in the presence of ultraviolet radiation at a wavelength selected for optimal acetate radical generation from peracetic acid.

10. The method of claim 9, wherein the wavelength is from about 160 nm to about 400 nm.

11. The method of claim 9, wherein the wavelength is from about 180 nm to about 380 nm.

12. The method of claim 9, wherein the wavelength is from about 200 nm to about 360 nm.

13. The method of claim 9, wherein the wavelength is from about 220 nm to about 340 nm.

14. The method of claim 9, wherein the wavelength is from about 240 nm to about 320 nm.

15. The method of claim 9, wherein the treatment comprises at least one of disinfection of vapor or water in residential, municipal, commercial, or industrial processes; surface sanitizing; destruction of microbial spores; production of chemical products or intermediates that utilize the acetate radical in their manufacture or purification; destruction of volatile organic compounds present in waste gases or air ventilation systems; destruction of environmental contaminants; bleaching of synthetic or natural products; delignification or predigestion of biomass materials; and modification or etching of material surfaces comprised of organic and/or inorganic substances.

16. A method of treating a medium with a peracetic acid solution in the presence of ultraviolet irradiation, wherein the treatment comprises at least one of disinfection of vapor or water in residential, municipal, commercial, or industrial processes; surface sanitizing; destruction of microbial spores; production of chemical products or intermediates that utilize the acetate radical in their manufacture or purification; destruction of volatile organic compounds present in waste gases or air ventilation systems; destruction of environmental contaminants; bleaching of synthetic or natural products; delignification or predigestion of biomass materials; and modification or etching of material surfaces comprised of organic and/or inorganic substances; and wherein the peracetic acid solution contains a weight ratio of peracetic acid to hydrogen peroxide of ≧3:1.

17. The method of claim 16 wherein the weight ratio of peracetic acid to hydrogen peroxide is ≧6:1.

18. The method of claim 17 wherein the weight ratio of peracetic acid to hydrogen peroxide is ≧10:1.

19. The method of claim 16 wherein the PAA solution is free or substantially free of acetic acid.

20. The method of claim 16 wherein the PAA solution is free or substantially free of mineral acid.
